(19) United States
(12) Patent Application Publication
(10) Pub. No.: US 2014/0278861 A1
(43) Pub. Date: Sep. 18, 2014

(54) USER DIRECTED DONATION SYSTEM AND METHOD

(71) Applicant: 4ME 4WE INC., Brentwood, MO (US)

(72) Inventors: Ben Bush, Brentwood, MO (US); David Challoner, Brentwood, MO (US)

(73) Assignee: 4Me 4We Inc., Brentwood, MO (US)

(21) Appl. No.: 13/836,046

(22) Filed: Mar. 15, 2013

(51) Int. Cl. G06Q 30/02

(52) U.S. Cl. CPC G06Q 30/0214; G06Q 30/0279
USPC 705/14.16

(57) ABSTRACT

A method and system for user-directed donations from a company to a charity in which an affiliate company agrees to donate a percentage of each transaction with a registered user to one or more charities selected by the user. The user may also select a percentage of each donation which is to be donated to each of its selected charities. The user conducts the transaction with a personal payment account, which is any form of payment which is not specific to a single company or related group of companies. In this way, the user may conduct business with substantially any business and generate donations which the user directs, so long as the business is an affiliate.

### FIELD OF INVENTION

This invention relates generally to directed donation system and method and, more particularly, to a user-controlled donation system and method allowing users to shop at any company and direct a portion of each transaction to charity.

### BACKGROUND ART

Presently, donations can originate from many sources. People may donate money or property directly to a charity. Businesses often donate money or goods to charities as well. However, businesses often try to use their charitable donations to attract additional customers. For example, a business may advertise that it donates to a specific charity, and hope that prospective customers will patronize the business in approval of such donations. Additionally, businesses may form a partnership with a specific charity, and advertise special programs in which a portion of sales—either during a given time period or of a certain type of good/service—will be donated to that charity. Again, businesses employ such programs in the hope that consumers will approve of the charitable donations, and increase or continue their level of patronization of such business.

Occasionally, businesses will form even stronger ties with a specific charity. The business may agree to sell or provide a gift card or other discount card to the charity for the charity to sell off. Typically, the gift card can be sold by the charity (and is redeemable at the business) for an amount which is higher than the amount paid by the charity for the gift cards. For example, the business may sell $20 gift cards to the charity for only $15 dollars. The business thereby “donates” the $5 difference between the value and price of the card to the charity, and in turn receives business from the people who purchase the gift cards from the charity.

Some businesses issue scrip cards to charities which hand out the cards to consumers. When a consumer scans the re-usable scrip card at point of sale, the business's computer system causes the business to donate a predetermined percentage of the sale to the charity associated with the scrip card. The user receives no discount, but the charity receives a donation.

However, each of the above methodologies presents problems for users and businesses and consumers. For example, when businesses associate themselves with specific charities, consumers who don't approve of that charity's goals and principles may avoid the business. Additionally, when charities buy discounted gift cards from businesses, they are somewhat gambling that consumers will want to buy those gift cards. However, a consumer that has no interest in the types of goods and services offered by that specific business may not be interested in gift cards from that business. Similarly, scrip cards can only be used for purchases at the business which issued them. A consumer is then forced to shop at that specific business if it wants a portion of the value of its transaction to be donated.

A remedy to alleviate these constraints on consumers and the risks on charities and businesses is needed

### BRIEF SUMMARY OF INVENTION

In one embodiment, the user directed donations system allows the user to do business with any affiliated organization, and cause a portion of the value of any transaction with such an affiliated organization to be donated to one or more charities of the user's choosing. The system allows organizations, such as businesses, to sign on as affiliates. Consumers can also sign on as users, at which point accounts are created for them.

Each affiliate agrees to donate a percentage of the value of each transaction which occurs between the affiliate and a user. The affiliate may select the percentage of the transaction which will be donated, and may change the selected percentage at any time for future transactions. Similarly, the user may select any legitimate, registered charity or charities to receive donations from its transactions with an affiliate. When a user selects more than one charity, the user may select the percentage of the total donation generated from each of its transactions that is to be is donated to each selected charity. The user may also change the percentages of the total donation generated which will go to its selected charities at any time.

By way of example, an affiliate may choose to donate 2% of each transaction with a user, and the user may select first and second charities which will receive 75% and 25% of generated donations, respectively. Thus, if the user spends $100 at the affiliate, the affiliate will donate 2% of that transaction—$2 in this case—to the first and second charities. The first charity receives 75% of the $2 donation, while the second charity receives 25%. Therefore, the first charity receives $1.50 ($100×0.02×0.75) while the second charity receives $0.50 ($100×0.02×0.25). It is noted that a small portion of each amount received from an affiliate—such as approximately 20%—may be retained by the system as payment to the system. In the above transaction, the actual amounts donated to the first and second charities would therefore actually be $1.20 and $0.40, with the remaining $0.40, or 20% of the $2 donation, being paid to the system. However, for ease of reference herein, transactions will be discussed without reference to such payments to the system, which are assumed.

In operation, a user's smartphone or PDA or tablet or the like may display a unique scannable code. It is noted that a scannable card or a unique ID may be used instead of a digitally displayed scannable code, although such embodiments are not preferred. At the point of sale at an affiliate location, the user may scan the code with the affiliate's scanner (or otherwise input the unique ID). During an online transaction, the user could input the identifier at the point of sale during the purchase process. Such identifier is preferably recognizable by any affiliate, and serves to associate the user with the transaction. In this manner, the affiliate system flags the transaction as requiring a donation. The affiliate system then communicates to the donation system that the user has participated in a sale which has generated a donation of a determined amount. The donation system then determines how much of that donation amount to route to each of the user's selected charities. The donation system then tracks the user's “activity,” both in terms of the location of the transaction itself, and the amount the transaction caused to be donated to the selected charities.

Alternatively, at point of sale, the affiliate may print out a receipt that includes a scannable object, such as a bar code or QR code, or a unique human-readable code. The amount of the transaction is encoded in the code. A user may then scan the printed code with, for example, a smartphone app which utilizes the phone's camera. Where the code is a human-readable code, the user may simply transmit the code to the donation system manually, such as by typing it into a mobile application associated with the donation system or into a website associated with the donation system. By scanning or otherwise inputting the code to the donation system, the donation system is made aware of the transaction and the amount to be donated to the user's selected charities. The actual donation and tracking then occurs as discussed above. However, at the end of a predetermined period, such as at the end of each month, the donation system may then reconcile its donations with the affiliates.

The donation system may also interact with one or more social networks as are commonly known. For example, the donation system may automatically, with the user's permission, post a message from the user's social networking account regarding the transaction. In this way, friends of the user can see that the user is actively contributing to charities, and may encourage the user's friends to participate as well. The donation system thereby leads to so-called “gamification,” in which individual users and/or groups of users can compete to cause the most donations to one or more charities.

Businesses may participate in this gamification by forming partnerships with certain charities and selecting those charities as preferred charities. The affiliate may donate a higher percentage of any transaction where the donation is routed to a preferred charity. For example, slightly modifying the above example, the affiliate may determine that the first charity is a preferred charity, and will therefore donate 4% of a given transaction rather than the standard 2% if the donation is routed to that charity. In the above example, if the user spends $100 with the affiliate, the affiliate will still donate $0.50 to the second charity ($100×0.02×0.25), but the first charity will receive $3 ($100×0.04×0.75). Thus, the business receives the benefit of partnering with one or more charities by appealing to those individuals who also support the preferred charities. However, individuals who do not support those charities are not as dissuaded from doing business with the affiliate, because those users can still ensure that the donations generated from their transactions are not routed to the preferred charities.

Gamification may also occur in other ways within the donation system. For example, the donation system may allow users to “wager” the donations it has generated with certain transactions (such as all those transactions made during a selected period of time) on the outcome of an event, such as a sporting event or television show. For example, for the week leading up to a large sporting event, the donation system may allow the user to opt into the wagering game. If the user opts in, any donations generated by the user's transactions with an affiliate would not be directly routed to a charity, but would instead be routed to the user's wager account. The user would then wager the amount of money in its wager account on the outcome of the sporting event. The amount in the wager account of all of the users who participate in the wager would then be pooled, and later split between the accounts of the users that win the wager, in accordance with the percentage that the user wagered as compared to other participating users, to be donated to those users' selected charities as normal.

For example, if ten people decide to wager on the outcome of the sporting event, each “wagering” $5 of donations earned during the week immediately preceding the sporting event, the total wager amount would be $50 (5$×10 participants). If half of the participants wagered that one team would win, while the other half wagered that the other team would win, the five participants who wagered correctly would each earn $10 ($50 pot/5 winners) to be donated to their charities of choice. The affiliates who actually donate the money still each donate the same amount. However, winning users get credit for double the donation to their selected charities, while the losing users do not get any credit for the donations they originally generated. The donations may alternatively be earned only within the venue of the event, and may only be wagered at that event.

The donation system preferably includes a computer system comprising one or more processors and a memory where executable software is stored and executed by the one or more processors, where the one or more programs include instructions for various modules executed by a processor. For example, the system may include a user account module which is responsible for allowing user interaction with the user's account (such as selecting charities and donation percentages to the selected charities). An affiliate account module may be responsible for allowing the affiliate to interact with its account (such as selecting the percentage of each transaction to be donated, and/or selecting preferred charities). A transaction tracking module may be responsible for communicating with affiliate systems to receive information on transactions occurring between a user and the affiliate, and/or may be responsible for interacting with the user's computing device to receive a scanned or manually inputted code generated by the affiliate's computer system following a transaction. A donation tracking module may be responsible for identifying an account receivable in an amount of money to be received from an affiliate based on the amount of a transaction with a user and the affiliate-determined percentage. The donation tracking module may also be responsible for apportioning the money to be received from each affiliate to the appropriate user's account to be distributed to the user's selected charities based on the user-selected donation percentages.

By tracking the transactions and the donations made, the donation system can provide reports to the user and/or charities and/or affiliates with the geographic location transactions which result in a donation to a selected charity. This allows charities to see where its user benefactors are physically shopping, thereby allowing the charities to target advertisements or commercials to those areas. Also, reports regarding the charities to which donations are being made based on transactions in a given geographic area may be available. This allows affiliates to see where users who shop in those locations are donating money, and allows the affiliates to best target its charity partnerships in given areas, allowing of donations made to a given

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a block diagram of a user directed donation system according to an embodiment of the present invention;

FIG. 2 is a flow chart of an example user directed donation method utilizing the system of FIG. 1 according to an embodiment of the present invention.

FIG. 3 is a reproduction of a screen capture of a web interface as seen by a user of the system of FIG. 1;

FIG. 4 is a reproduction of a screen capture of a web interface as seen by a user of the system of FIG. 1, who is participating in a group;

FIG. 5 is a reproduction of a screen capture of a web interface as seen by an affiliate when creating a new campaign.

FIG. 6 is a flow chart of an example user directed donation method in which wagering occurs, according to an embodiment of the present invention.

FIG. 7 is a reproduction of a screen capture of a web interface showing information relating to an affiliate as seen by a user.

FIG. 8 is a reproduction of a screen capture of a web interface showing information relating to a charity as seen by a user.

FIG. 9 is a screen capture of a web interface showing centers of influence.

FIG. 10 is a reproduction of a screen capture of a mobile app interface showing location-specific data.

FIG. 11 illustrates a flow chart of one embodiment of a web interface for allowing a user to create and manage its user account.

FIG. 12 illustrates a flow chart of one embodiment of a web interface for allowing a user to select and edit charities and donation percentages.

FIG. 13A illustrates a flow chart of one embodiment of a transaction tracking and donation making procedure when using a mobile device.

FIG. 13B illustrates a flow chart of one embodiment of a transaction tracking and donation making procedure when using a laptop or desktop.

FIG. 14 illustrates a flow chart of one embodiment of a web interface for group creation access.

FIG. 15 illustrates flow chart of one embodiment of a web interface relating to user-selected locations and the options associated with same.

FIG. 16 illustrates flow chart of one embodiment for allowing a user to create and modify social networking options.

FIG. 17 illustrates a flow chart of one embodiment of integration with social networking which demonstrates such gamification.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

According to the embodiment(s) of the present invention, various views are illustrated in FIGS. 1-10 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of a user directed donations system 100 according to the present invention includes a user account module 105, an affiliate account module 110, a transaction tracking module 115, a donation tracking module 120, a tracking module 125, and a social networking module 130. Such modules are preferably executed by one or more processors based on instructions stored in an electronic memory, all included in a central computing system. The operation of system 100 will be discussed in terms of method 200 shown in FIG. 2.

At step 205, a user 10 creates and manages a user account via a user computing device 15 interacting with user account module 105 over a network. FIG. 11 illustrates a flow chart of one embodiment for allowing a user to create and manage its user account, including integration with social networks such as FACEBOOK®, TWITTER® (discussed in detail below) and GOOGLE+®. User computing device 15 may be a desktop computer, a laptop computer, a smartphone, a PDA, a tablet or the like. FIG. 12 illustrates a flow chart of one embodiment for allowing a user to select and edit charities and donation percentages. User account module allows the user to select one or more charities to receive donations, and allows the user to assign a donation percentage to be received by each selected charity.

Similarly, at step 210, an organization, such as a business, becomes an affiliate 20 by signing up with affiliate account module 110. An affiliate's computer system 30 further communicates with the affiliate account module 110 to select an affiliate-determined percentage of each transaction which occurs with a registered user to be donated to that user's selected charities. The affiliate's computer system 30 may, like the user's computing device 15, be any type of suitable of electronic device. Additionally, both the user 10 and the affiliate 20 may change its selections for all future transactions at any time.

Once both the user 10 and affiliate 20 are signed up, the user 10 may choose to conduct a transaction with the affiliate at step 215. Preferably, user 10 interacts with the affiliate sales system 20 at a point-of-sale, either directly (such as in a store) or via the user's computing device 15 (such as during an online purchase) to conduct the transaction. As payment during the transaction, the user utilizes a personal payment account, which is preferably any form of payment which may be used at substantially any business, and is not specific to a business or a group of commonly owned or associated businesses. For example, a personal payment account may include cash, check, credit card, debit card, etc., all of which are widely used at unrelated, unaffiliated businesses. However, a personal payment account does not include a store-specific gift card, a store-specific line of credit, etc., which may only be used at a single store or a group of commonly owned or associated businesses. It is important to note that the any user 10 may transact with any affiliate 20 with the personal payment account. System 100 and method 200 do not restrict the user 10 to which charities 40 it may donate to, or to companies from which it must do business (except insofar as the company must be signed on as an affiliate 20, although any company may sign on as an affiliate 20 and therefore the user 10 is theoretically not restricted).

Once the user 10 completes a transaction with the affiliate 20, the transaction tracking module 115 receives transaction data regarding the transaction at step 220. The transaction data may come from the affiliate 20 and/or the user 10. In one embodiment, the user 10 may input a unique identifier into the affiliate's sales system 25 at the time of the transaction. For example, the user 10 may have an ID code which it manually enters into the affiliate's sales system 25, or the user 10 may carry a physical card or digitally display a code which can be scanned by the affiliate's point of sale systems. Receiving the unique identifier causes the affiliate to flag the transaction as relating to system 100 and method 200, and causes the affiliate computer system 30 to transmit the transaction data to the transaction tracking module 115.

Alternatively, rather than causing the affiliate computer system 30 to communicate with the transaction tracking module 115, receiving the unique identifier may merely cause the affiliate's sales system 25 to provide the user 10 with a single-use transaction identifier. The single use transaction identifier may similarly take the form of an ID code or a scannable code (such as a QR code or barcode or other such code as is known in the art), and may be printed on the physical receipt given to the user 10 at point of sale, or may be digitally displayed on the digital receipt provided to the user 10 after an online transaction. The single-use transaction identifier preferably includes similar information as was discussed above as being transmitted to the transaction tracking module 115 from the affiliate computer system 30, although additional information which identifies the affiliate itself may also be included. The user 10 preferably uses an app or other program (as will be discussed in detail below) to scan the code, such as by taking a photograph of it with a smartphone, or manually inputs the code via the user's personal computing device 15. The single-use transaction identifier is preferably only good for one upload, so that it cannot be rescanned or reentered in an attempt to generate inappropriate duplicate donations.

Either mechanism for transmitting data to the transaction tracking module 115 at step 220 is acceptable, and both may occur simultaneously. Where both the user 10 and the affiliate 20 report the transaction to the transaction tracking module 115, the transaction tracking module checks to make sure the dual reports match. Where only the user 10 reports the transaction, the transaction tracking module 115 preferably reconciles with the affiliate computer system 30 periodically to ensure that all reported transactions were similarly recorded by the affiliate 20.

At step 225, donation tracking module 120 identifies an account receivable in an amount of money to be received from the affiliate 20. This amount of money may have been pre-calculated by the affiliate 20 prior to transmission of the transaction data at step 220. However, where the full transaction amount is transmitted to the transaction tracking module 115 rather than just the donation amount, donation tracking module 120 calculates the appropriate donation amount based on the transaction amount and the affiliate-determined percentage. Other factors may also be taken into account, such as whether the donation is being made to a preferred charity, as will be discussed in detail below. The amount of money of the account receivable is then apportioned to the user's account to be donated to each of the user's selected charities based on the user's selected donation percentages at step 230, and is donated to the user's chosen charities accordingly at step 235. At step 240, the donation tracking module 120 communicates with the affiliate account module 110 and the user account module 105 to update the user and affiliate accounts with the information regarding the donation(s). FIG. 13A illustrates a flow chart of one embodiment of the above discussed transaction tracking and donation making procedure via a smartphone, tablet or other mobile device, while FIG. 13B illustrates a flow chart of one embodiment of the above discussed transaction tracking and donation making procedure via a laptop or desktop computer. It is noted that the order of steps including making donations and receiving moneys from affiliates is not important. Money may be donated and then recouped from affiliates, or the affiliates may pay into the system before donations are made.

FIG. 3 illustrates a reproduction of a screenshot of an example web interface 300 generated by the user account module 105 for user 10. As shown, the web interface lists user information 305, including the user's name or screen name, location, etc. Also shown are the user's selected charities 310. The user may choose to add new charities or replace previously chosen charities at any time for all future transactions. The user may select the percentage of each donation which is to be apportioned to each charity with slider bar 315, although it is understood that other methods of setting percentages are contemplated. The user's web interface may also show the total money 320 that the user has generated for its charities, and/or a breakdown of how much has been given to individual charities. In some embodiments, generating donations or otherwise participating in games or other events may also generate “experience points.” As a user 10 gains experience, the user's level progresses. Certain options or awards may be available to a user 10 only up reaching a certain level. It is noted that a web interface for an affiliate 20, as generated by affiliate account module 110, may include many of the same features. However, rather than selecting donation percentages for charities, an affiliate's web interface preferably allows it to set its affiliate-determined percentage.

FIG. 4 illustrates a reproduction of a screenshot of an example group web interface 400 generated by the user account module 105 for a user 10 who is participating in a group. The system 100 allows for multiple users 10 to team up and track all of the donations made by group members to selected charities. The group web interface 400 lists the group information 405, which may include the name of the group, the number and/or names of users 10 in the group, the charity or charities to which the group is donating, etc. As with the user's web interface 300, the group web interface 400 may also display the total donations 410 amassed by group members for the group's charities. However, unlike the user's web interface 300, the group web interface may also list rivals 415 against which the group is competing. When setting up a group, the group may challenge other existing groups, or may leave an open challenge for other groups. Alternatively, a group may enter a challenge set up by another group, or by a charity 40 or by an affiliate 20. Thus, the system 100 provides for the gamification of donations. Challenges may occur via social network. Users 10 and groups of users 10 may compete against others to generate donations to charities. FIG. 14 illustrates a flow chart of one embodiment of a group-oriented web interface.

FIG. 5 illustrates a reproduction of a screenshot of an example affiliate campaign interface 500 generated by the affiliate account module 110 for an affiliate 20 wishing to create a new campaign. It is noted that a group or a charity 40 may also set up a campaign via a similar interface. As can be seen, affiliate campaign interface 500 includes a charity selection portion 505 which allows the affiliate 20 to select one or more charities 40 which it wishes to include in the campaign, as well as an incentive addition portion 510 which allows the affiliate 20 to add some sort of a prize to the campaign. An affiliate 20 may therefore set up a campaign and allow users or groups to compete to see who can generate the most donations for the selected charity or charities based on transactions made with that affiliate 20 (or other selected affiliates), and provide a prize to the winner. The affiliate 20 may set various targeting requirements 515 for the campaign, such as gender, age range, location, etc., to better target its campaign to its desired demographic. Similarly, the affiliate may set date/time restrictions 520 on the campaign. Thus, affiliates 20 may use gamification and targeting of system 100 to reach desired demographics in desired locations. Campaigns which support certain charities are generally less problematic to consumers who dislike those charities, because the consumer can ensure that donations it generates are not given to the charities they dislike.

It is also noted that an affiliate 20 may choose to make the affiliate-determined percentage vary based on many factors. For example, a restaurant affiliate wishing to increase its sales between the lunch and dinner rushes may choose to increase the affiliate-determined percentage during its off hours. Similarly, a large chain retailer may choose to increase its affiliate-determined percentage at stores trying to generate more business. An affiliate 20 may also decide to make certain charities “preferred” charities, and may choose to increase the affiliate-determined percentage for any donations made to those charities. For example, the affiliate 20 may determine that a first charity is a preferred charity, and will therefore donate 4% of a given transaction rather than its standard 2% if the donation is routed to that charity. If a user 10 selects both the first and second charities and allocates its donations 75/25 respectively, and then spends $100 with the affiliate 20, the affiliate 20 will donate $0.50 to the second charity ($100×0.02×0.25), but the first charity will receive $3 ($100×0.04×0.75). Thus, the affiliate 20 receives the benefit of partnering with one or more charities 40 by appealing to those users 10 who also support the preferred charities. However, individuals who do not support those charities are not as dissuaded from doing business with the affiliate, because those users can still ensure that the donations generated from their transactions with the affiliate are not routed to the affiliate's preferred charities.

In another embodiment, as shown by the method 600 in the flowchart of FIG. 6, the amount of money in an account receivable from an affiliate 20 may be used to wager on the outcome of an event. At step 605, users 10 may choose to wager a portion of future donations created by their respective transactions over a period of time. Each user 10 may select a wagering percentage which allocates up to 100% of newly created donation amounts to its wager(s), preferably in the same way users 10 select donation percentages. At step 610, those users 10 then conduct transactions with affiliates 20 as normal, and the system 100 identifies accounts receivable of amounts of money for each such transaction. However, rather than apportioning those funds to the users' respective accounts for donation, the funds are apportioned between the users' respective accounts and the users' respective wagering accounts based on the wagering percentages selected. Thus, users 10 can amass funds to be wagered in wagering accounts. It is noted that separate wagering accounts may be set up, or system 100 may maintain all wagering and non-wagering funds in a single account, and simply tracking the total of said wagering funds.

At step 615, users 10 who have chosen to make a wager can make such wager on the outcome of an event. For example, users 10 may wager on the winner of a sporting event. Users 10 may choose to wager all or just a portion of the funds in their respective wager accounts. After the event occurs, at step 620 the wagered funds are deducted from the wager accounts of those users 10 who incorrectly guessed the outcome of the event. The deducted funds is then pooled and split between the users 10 who correctly guessed the outcome of the event. The losing users' wagered funds are preferably split among the winning users 10 in percentages which correspond to the amounts wagered by the winning users 10. At step 625, the funds won by the winning users 10 is apportioned to the winning users' respective accounts, and at step 630, the donation tracking module donates the won funds appropriately as discussed above. The donation tracking module 120 or another module may be responsible for the wagering procedure discussed above.

As shown in FIG. 1, system 100 may also include a tracking module 125 which tracks information regarding transactions between users 10 and affiliates 20, and regarding donations made to various charities 40. Tracking module 125 may track information including: the geographic location of qualifying transactions by a user 10; the geographic location of all qualifying transactions with an affiliate 20; the geographic location of all qualifying transactions which result in a donation to a charity 40; the demographics of all users 10 who conduct transactions with an affiliate 20; the demographics of all users 10 who donate to a charity 40; total amount donated by an affiliate 20 to one or more charities 40, or caused to be donated to one or more charities 40 by a user 10. Additionally, tracking module 125 may track temporally, such as donations as a function of time, and the types of goods/services which are offered by affiliates with which users 10 conduct transactions. Additionally, tracking module 125 may track the type of personal payment account used by users 10 during transactions with affiliates 20.

For example, FIG. 7 illustrates a reproduction of a screenshot of an example web interface 700 generated by the user account module 105 for a user 10 who is reviewing statistics of an affiliate 20. As can be seen, the interface 700 may display the affiliate's general information 705, such as the name, address and a logo of the affiliate 20. A running total of funds donated 710 by the affiliate 20 through system 100 is shown, as well as users top users 715 who have generated the most in donations via the affiliate 20, as tracked by the tracking module 125. The web interface 700 may also display current campaigns 720 in which the affiliate is participating. FIG. 8 illustrates a similar web interface 800 generated by the user account module 105 for a user 10 who is reviewing statistics of a charity 40. Web interface 800 includes similar information, such as the charity's general information 805, and a running total of funds donated 810 to the charity 40 through system 100. The web interface also shows top users 815 who have generated the most in donations to the charity 40, as tracked by the tracking module 125. The web interface 800 may also display current campaigns 820 in which benefit the charity 40.

Information which is tracked by tracking module 125 may also be displayed graphically rather than numerically, as shown in FIG. 9. FIG. 9 is a screen capture of a web interface showing centers of influence via a heat map 900. Specific transaction locations 905 are shown by flags. The heat map 900 illustrates different influence intensities by different colors 910, 915, 920 shaded on the map. As can be seen, color 910 is shown as being substantially centered on a majority of the transactions 905, which indicate that the highest level of influence has been centered on those areas. Colors 915 and 920 signify lower levels of influence. Preferably, influence is affected not only by the number of transactions in an area, but also by the value of those transactions. Clicking on a map pin 905 may direct the user to a maps-based application to provide retail affiliate contact info and directions, or may provide the affiliate with marketing/brand support. As shown in FIG. 9, influence specifically relates to transactions made between users 10 and affiliates 20 which create donations. However, similar influence heat maps may be created which are specific to a user 10, to a group of users, to an affiliate 20 or to a charity 40. FIG. 15 illustrates flow chart of one embodiment of a web interface relating to user-selected locations and the options associated with same, such as the above discussed heat maps.

As shown in FIG. 1, system 100 may also include a social networking module 130 which communicates with one or more of the various social networks commonly known. For example, a user 10 may give system 100 permission to make posts via the user's social networking account by inputting their username and password to the social networking account. FIG. 16 illustrates flow chart of one embodiment for allowing a user to create and modify social networking options. The social networking module 130 may then post a status update or a message via that social network that the user 10 has generated a donation when such a donation is generated. Similarly, the social networking module 130 may allow the user 10 to promote a campaign or a charity, or challenge another user 10 or group of users 10 via a social network. As noted above, this integration with social networks increases the possibilities for gamification. FIG. 17 illustrates a flow chart of one embodiment of integration with social networking which demonstrates such gamification.

Tracking module 125 may also track social networking related information, such as the number of status updates or posts made by or regarding system 100, the number of times a user 10 has “checked in” at an affiliate location via system 100 or the demographics of such users, the number of times a user 10 has liked or recommended a status update relating to system 100 or the demographics of such users, etc. Tracking module 125 may track information including: the geographic location of qualifying transactions by a user 10; the geographic location of all qualifying transactions with an affiliate 20; the geographic location of all qualifying transactions which result in a donation to a charity 40; the demographics of all users 10 who conduct transactions with an affiliate 20; the demographics of all users 10 who donate to a charity 40; total amount donated by an affiliate 20 to one or more charities 40, or caused to be donated to one or more charities 40 by a user 10.

As noted above, user 10 may interact with the user account module 105 via a mobile computing device such as a smartphone, PDA or tablet 15 running a mobile application. Preferably, a mobile app will allow a user 10 to do substantially the same things as the web interfaces discussed above, with additional location specific features. For example, FIG. 10 illustrates mobile app feature which allows a user to find nearby campaigns. A button 1005 allows the user 10 to request nearby campaigns, and a list of nearby campaigns 1010 is then displayed. The location of nearby affiliates 20 and/or affiliates involved in specific campaigns may be displayed to the user 10 on a map. The user 10 may be able to access tracked information relating to specific nearby affiliates 20 and/or transactions as well.

The various web and mobile app interface examples and flowcharts discussed above illustrate a system and method for allowing user-directed donation from companies to charities. A user of the present invention may choose any of the above implementations, or an equivalent thereof, depending upon the desired application. In this regard, it is recognized that various forms of the above interfaces and systems could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention. Additionally, it is accordingly intended that the claims shall cover all such modifications and applications that do not depart from the spirit and scope of the present implementation, and the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example embodiment, a computer system may operate as a standalone device or may be connected (e.g., networked) to other machines. In a networked deployment, the computer system may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is often illustrated, the term “computer system” or “computing device” shall also be taken to include any collection of machines that individually or jointly execute a set (or multiple sets) of instructions to perform any one or more of the methodologies discussed herein.

A computer system and/or computing device can include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). A computer system may also include an alphanumeric input device (e.g., a keyboard), a cursor control device (e.g., a mouse), a drive unit, a signal generation device (e.g., a speaker) and a network interface device.

One or more sets of instructions (e.g., software) embodying any one or more of the methodologies or systems described herein is envisioned. The software may reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

Other aspects, objects and advantages of the present invention can be obtained from a study of the drawings, the disclosure and the appended claims.

What is claimed is:

1. A method for directing a portion of a user's payment for a purchase at an affiliate, the method comprising the steps of:
receiving at a central computing system over a network a user's selection of charities to receive a donation;
receiving at the central computing system over the network the user's selection of a donation percentage for each selected charity;
tracking the user's purchases made at a point-of-sale with a personal payment account at an affiliate;
for each of said user's purchases at the affiliate, identifying an account receivable in an amount of money to be received from the affiliate, said amount of money corresponding to an affiliate-determined percentage of an amount of said purchase;
apportioning the money to be received from each affiliate relating to the user's purchases to the user's account to be distributed to selected charities based on the user-selected donation percentages.

2. The method of claim 1 wherein the user may modify its selected charities at any time for future transactions.

3. The method of claim 1 wherein the user may modify its selected donation percentage at any time for future transactions.

4. The method of claim 1 wherein the affiliate may modify its affiliate-determined percentage at any time for donations which would be apportioned to one or more preferred charities.

5. The method of claim 1 wherein the personal payment account includes any payment method which not specific to a single affiliate or to a related group of affiliates.

6. The method of claim 5 wherein personal payment account includes cash, check, credit card or debit card.

7. The method of claim 1 further including the step of:
storing user information at the computer system relating to donations directed to charities on behalf of the user; and
storing affiliate information at the computer system relating to donations made to charities by an affiliate.

8. The method of claim 1 further including the step of:
storing geographic information at the computer system relating to the geographic location of purchases which result in donations to a given charity and providing secured access to the geographic information to the charity.

9. The method of claim 1 further including the step of:
storing information relating to the charities which receive donations from purchases made in a selected geographic region.

10. A system for directing donations comprising:
a central computer system comprising one or more processors and a memory where executable software is stored on said memory and executed by the one or more processors, where the one or more programs include:
instructions for a user account module, said user account module communicating with a user's computing device, and allowing the user to register an account, select charities to receive a donation and select a donation percentage for each selected charity;
instructions for an affiliate account module, said affiliate account module communicating with an organization's computer system, and allowing the organization to register as an affiliate and select an affiliate-determined percentage of each qualifying financial transaction to be donated;
instructions for a transaction tracking module, said transaction tracking module receiving transaction data regarding the user's transactions with an affiliate made at a point-of-sale with a personal payment account; and
instructions for a donation tracking module, said donation tracking module identifying an account receivable, based on the transaction data and the affiliate's affiliate-determined percentage, in an amount of money to be received from the affiliate, and apportioning the money to be received from the affiliate to the user's account to be donated to each of the said user's selected charities based on the user's selected donation percentages.

11. The system of claim 1 wherein the user account module allows the user to modify its selected charities at any time for future transactions.

12. The system of claim 1 wherein the user account module allows the user to modify its selected donation percentage at any time for future transactions.

13. The system of claim 1 wherein the affiliate account module allows the affiliate to modify its affiliate-determined percentage at any time for donations which would be apportioned to one or more preferred charities.

14. The system of claim 1 wherein the personal payment account includes any payment method which not specific to a single affiliate or to a related group of affiliates.

15. The system of claim 14 wherein personal payment account includes cash, check, credit card or debit card.

16. The system of claim 10 further including:
instructions for a tracking module, where said tracking module stores user information relating to donations directed to charities on behalf of the user, and stores affiliate information relating to donations made to charities by an affiliate.

17. The system of claim 10 further including:
instructions for a tracking module, where said tracking module stores geographic information relating to the geographic location of purchases which result in donations to a given charity and provides secured access to the geographic information to the charity.

18. The system of claim 10 wherein the user's computing device includes a computer which interacts with the user account module via a website available via the Internet.

19. The system of claim 10 wherein the user's computing device is mobile and interacts with the user account module via a mobile application.

20. The system of claim 10 further including:
Instructions for a social networking module, where said social networking module communicates with at least one external social networking website to cause the social networking website to display information relating to donations made.

21. A method for directing donations, the method comprising the steps of:
receiving at a central computing system over a network a user's selection of charities to receive a donation;
receiving at the central computing system over the network the user's selection of a donation percentage for each selected charity;
tracking the user's purchases made at a point-of-sale with a personal payment account at an affiliate;
for each of said user's purchases at the affiliate, identifying an account receivable in an amount of money to be received from the affiliate, said amount of money corresponding to an affiliate-determined percentage of an amount of said purchase;
allowing the user to wager, on the outcome of an event, at least a portion of a total amount of money identified as accounts receivable to be received from affiliates during a period of time;
aggregating all such wagers from a plurality of users;
dividing the aggregated wagers among the wagering users whose wagers are won; and
apportioning the divided aggregated wager money to each user's selected charities based on the user-selected donation percentages.
apportioning the divided aggregated wager money to the users' accounts to be distributed to selected charities based on the user-selected donation percentages.

22. A system for directing donations comprising:
a central computer system comprising one or more processors and a memory where executable software is stored on said memory and executed by the one or more processors, where the one or more programs include:
instructions for a user account module, said user account module communicating with a user's computing device, and allowing the user to register an account, select charities to receive a donation and select a donation percentage for each selected charity;
instructions for an affiliate account module, said affiliate account module communicating with an organization's computer system, and allowing the organization to register as an affiliate and select an affiliate-determined percentage of each qualifying financial transaction to be donated;
instructions for a transaction tracking module, said transaction tracking module receiving transaction data regarding the user's transactions with an affiliate made at a point-of-sale with a personal payment account; and
instructions for a donation tracking module, said donation tracking module:
identifying an account receivable, based on the transaction data and the affiliate's affiliate-determined percentage, in an amount of money to be received from the affiliate, allowing the user to wager, on the outcome of an event, at least a portion of a total amount of money identified as accounts receivable to be received from affiliates during a period of time;
aggregating all such wagers from a plurality of users;
dividing the aggregated wagers among the wagering users whose wagers are won; and
apportioning the divided aggregated wager money to each of the users' selected charities based on the user-selected donation percentages.

23. A method for directing a portion of a user's payment for a transaction at an affiliate, the method comprising the steps of:
registering a user as a participant and creating an account in which the user selects of one or more charities, and selects a donation percentage for each selected charity;
affiliating a plurality of unrelated organizations to become affiliate organizations which each select an affiliate-determined percentage of each qualifying financial transaction to be donated;
allowing the user to select which affiliate organizations to do business with;
receiving donation data regarding the user's transactions with an affiliate made at a point-of-sale with a personal payment account;
identifying an account receivable, based on the donation data and the affiliate's affiliate-determined percentage, in an amount of money to be received from the affiliate;
crediting the user's account with the amount of the account receivable;
making a donation to each of the said user's selected charities as a proportion of the amount of the account receivable based on the user's selected donation percentages.

24. The method of claim 23, further including the steps of:
storing geographic information relating to the geographic location of purchases which result in donations; and
displaying a heat map of donations generated based on at least one of: the charity receiving the donations, the affiliate making the donations, and the user generating the donations.
